(19) United States
(12) Patent Application Publication
(10) Pub. No.: US 2026/0087544 A1
(43) Pub. Date: Mar. 26, 2026

(54) SYSTEM AND METHOD FOR QUANTUM COMPUTING UTILITIES TRANSACTIONS IN A Networked EXCHANGE MARKETPLACE

(71) Applicant: 8ORCAS, Inc., Dover, DE (US)

(72) Inventors: Anna E. Shebanow, Dover, DE (US); Jack Wolosewicz, San Francisco, CA (US)

(73) Assignee: 8ORCAS, Inc., Dover, DE (US)

(21) Appl. No.: 19/321,934

(22) Filed: Sep. 8, 2025

Related U.S. Application Data
(60) Provisional application No. 63/698,371, filed on Sep. 24, 2024.

(51) Int. Cl. G06Q 30/0645; G06N 10/80; G06Q 40/04

(52) U.S. Cl. CPC G06Q 30/0645; G06N 10/80; G06Q 40/046

(57) ABSTRACT

The technology disclosed describes a Quantum Utility Exchange (QUE) framework for managing and trading Quantum Utility Exchange Traded Resources (QU-ETRs). Providers define quantum resource packages (with time windows, usage limits, and resource specifications) and list them in a Recorded Database. Entities granted usage rights can trade these packages on the QUE through buy, sell, swap, or bid transactions, with all ownership transfers recorded and expired/consumed packages delisted. A Pending Database supports offers to buy or sell, searchable with AI/ML tools. The exchange uses secure blockchain-based communications, encrypted private tunnels, and verification processes to ensure integrity. Interfaces for providers and consumers enable package submission, searching, bidding, and downloading through a networked computer system. QU-ETRs can be traded under flexible contract types (“buy now-use now/later” or swaps), with transaction, validation, and alert mechanisms built into the system. Overall, the method establishes a secure, structured marketplace for allocating and exchanging quantum computing resources.

### PRIORITY DATA

This application claims the benefit of and priority to U.S. Provisional Patent Application No. 63/698,371, titled “SYSTEM AND METHOD FOR QUANTUM COMPUTING UTILITIES TRANSACTIONS IN A NETWORKED EXCHANGE MARKETPLACE,” filed on Sep. 24, 2024 (Attorney Docket No. ORCA1000USP01). The priority provisional application is incorporated herein by reference in its entirety and for all purposes as if completely and fully set forth herein.

### FIELD OF THE TECHNOLOGY DISCLOSED

The present technology disclosed pertains generally to methods for transactions on quantum computing Utilities, including more particularly to methods for purchasing quantum computing resource packages in a networked exchange marketplace for the purpose of providing access to quantum computing offered by many quantum computing utilities service providers, to address cybersecurity vulnerabilities posed by quantum computing advancements, improved utilities allocation, improved utilization, more choices for consumers of such utilities, and the establishment of fair market values for quantum computing utilities.

### BACKGROUND OF THE TECHNOLOGY DISCLOSED

One of the most challenging issues related to quantum computing is the cost. Most organizations will not be able to have in-house quantum computing for their operations. Another challenging task for consumers of quantum computing is the accessibility to utilities from many service providers. Another challenge related to quantum computing is that service providers are not able accurately forecast usage and required utilities, factors that raise the cost of quantum computing operations for service providers organizations. In a dynamic and inter-organizational setting, the scheduling and pricing of quantum utilities are key challenges, that is deciding which user can access what utility at what time at what price cost, and for what purpose. Sudden surges in demand and underutilization of utilities cause quantum computing service providers to lose revenue creating the need for a more efficient market model. Market mechanisms show promise for enhancing quantum computing utilities allocation and pricing in quantum computing. The shortcomings associated with the supply-and-demand of quantum computing utilities have heretofore not been adequately addressed. The present technology disclosed addresses such problems by providing a novel system and processing approach, and to address the businesses needs addressing the protection of assets and use to solve business and scientific problems in speedy manner.

### SUMMARY OF THE TECHNOLOGY DISCLOSED

An object of this technology disclosed is to provide a new method for optimizing quantum computing utilities allocation, utilization, and provisioning with competition for both sides, buyers and sellers, using a computer network to gain access to quantum computing utilities packages in an exchange marketplace environment by means of different contract types such as “buy now-pay now-use now”, “buy now-pay now-use later”, “buy now-pay later-use later”, or swap what has been bought for other utilities, and/or other means of contracts.

It is a further object of this technology disclosed to represent quantum computing utilities as a form of technology property and traded as such. That is, by structuring quantum computing utilities into packages by service providers that specify a range of time availability and potentially other constraints, we create an exchange marketplace where customers can conduct transaction on quantum packages placed by quantum service providers on the exchange marketplace. Since utilities are now tradable, we can let market forces determine the proper price point for these utilities and better match supply to demand. We define a package at minimum as a description of utilities and time window for which such utilities might be used, and we define the ability for a consumer to use these utilities at the specified time window package right of use. Package right of use is in a sense ownership of a package.

Another object of this technology disclosed is the concept that such packages can be made generic and interchangeable. In this technology disclosed, we call generic forms of packages Quantum Utility Exchange Traded Resources (QU-ETRs). QU-ETRs are in effect templates for packages. The QU-ETR concept enables service providers to generically define a class of utility packages making them interchangeable to an end user.

Another object of this technology disclosed is the definition of a Quantum Utility Exchange (QUE), a networked market in which packages and QU-ETRs can be in transactions much like other forms of items that can be purchased or sold. Bids to either buy or sell quantum utilities packages and/or QU-ETRs can be placed, more complex forms of transactions are also possible.

A further object of this technology disclosed derives from another the implementation of the embodiment. In the embodiment, software designed to execute the functionality of a marketplace is executed by at least one of the one or more processing units on a server computer system to allow users to participate in the marketplace by using an application programming interface (API) key.

Another object of this technology disclosed is to have a pair of data bases which are employed to record pending buy/sell bids and to record completed sales. Since this information contains a record of past and present market activity for packages and QU-ETRs, savvy providers, consumers suitably connected to the information contained in the databases can employ data mining to predict future demand, future pricing trends, or any other statistic desired. By having such information at their disposal, users and organizations transacting actively in quantum computing utilities can better predict demand and better optimize their use and offering of quantum computing utilities.

Another object of this technology disclosed is to use the blockchain technology to store, manage, and retrieve permissions, and access for information. The blockchain implementation employs a security attribute model, such as Oracle® Label Security, to record and enforce access permissions for data. Blockchain technology enhances transaction security and increases transparency between quantum service providers and consumers. When either party requests access, the blockchain verifies permissions and identities, enabling security information retrieval. The blockchain provides traceability and blocks access from unwanted and unidentified entities which helps quantum service providers to be in control of entities using their quantum utilities. Quantum service providers can use prompt to identify the entities who have used their quantum utilities and offer other utilities or block them from using their future utilities. All the data activities from both sides the service providers and consumers will be a part of blockchain.

A further object of this technology disclosed derives from another the implementation of the embodiment. In the embodiment, the communication between buyers and sellers is established and conducted through instructions on the computing system based on identity tokens, then the identify tokens are communicated to the security software module to determine if the API key is a valid key. The computer system generates the identity tokens through a cryptographic token generation script when the API key to be valid by the system. API key is uniquely associated with a single organization or a user or a buyer or seller and establishes an association between the identity token and the organization/user/buyer or seller. The transmitted information between parties is encrypted. Encrypted information is sent and received and is signed with a cryptographic digital signature and identity tokens. The receiving comprises decrypting the information using the identity tokens to form decrypted information and validation of signature. The identify tokens related activities are stored in a database. Other techniques of security mechanism can also be implemented for faster and better identity tokens. Buyers of quantum utilities can invoke AI prompt action to request package type and its information, and request information, or ask to provide any quantum machine learning approach to get the best solution for a problem, or simulate a problem using quantum machine learning or other techniques, or search for a particular information using quantum machine learning techniques, also can be based on package configuration types, cost, date, and more.

### BRIEF DESCRIPTION OF THE DRAWINGS

In the following description, numerous specific details are set forth to provide a more thorough understanding of the present technology disclosed. However, it will be apparent to one skilled in the art that the present technology disclosed may be practiced without one or more of these specific details. In other instances, well-known features have not been described in order to avoid obscuring the present technology disclosed. The technologies disclosed and described herein in terms for quantum utilities exchange marketplace server utilizing the Internet and the World Wide Web. However, after reading this description, it will be apparent how to implement the technology disclosed in alternative embodiments and alternative network environments. For example, alternative network environments include any large-scale wide area network and its accompanying networking protocols which may encompass one or more functions now provided by today's Internet, cable and broadcast television, telephone communications and other linear and interactive business and telecommunications systems. As such, the description of this example embodiment should not be construed to limit the scope and breadth of the technologies disclosed as claimed herein.

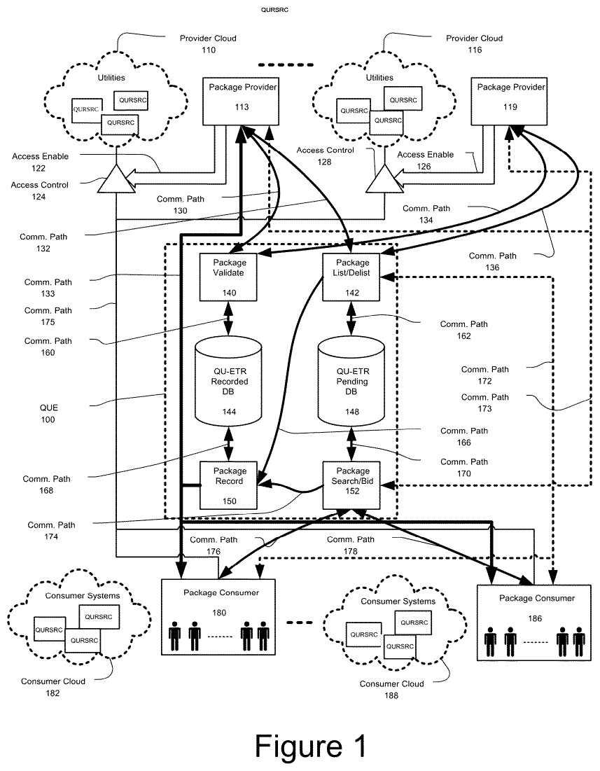

An example of an electronic Quantum Utilities Exchange (QUE) implementation is shown in FIG. 1.

### DETAILED DESCRIPTION

An organization is a group of two or more people and/or other organizations or subsets thereof grouped together for some purpose. Examples of organizations include but are not limited to corporations, partnerships, and trusts. Organizations can band together with other organizations, parts of organizations, or individuals to form new organizations. In order to simplify future discussions regarding individuals or organizations, we define an entity as either a single person or an organization.

A utility is either some tangible equipment or property owned or otherwise controlled by an entity or an intangible capability that can be applied or otherwise controlled by some entity. Examples of tangible utility apropos to this technology disclosed include but are not limited to quantum technology, computer equipment, storage equipment, communication equipment, any aspect of quantum technology, software, and I/O devices such as printers or terminals. Examples of intangible resources include but are not limited to consulting services, warranties, customer support, and quantum as well as IT administrative support.

In the context of this technology disclosed, there are several types of entities. First, provider entities are those entities that own and/or manage one or more quantum utilities and make these utilities available for use by other entities. Henceforth, they will simply be referred to as providers. Examples of providers include but are not limited to corporations that own and maintain a quantum computer cluster and make that quantum cluster available or use by outside organizations or individuals. Consumer entities are those entities that utilize one or more utilities for some application of their own choosing. Henceforth, they will simply be referred to as consumers.

A time window is a specific range of dates and times inclusive of and commencing with a start date and start time and inclusive of and terminating at an end date and end time. To avoid ambiguity in the specification of start and end times, these times might be specified in coordinated universal time (UTC). Utilities-time is the cumulative application of a quantum resource for a given amount of time, time being measured as a difference in UTC. For example, if a computer executes a computer program for 1 hour and at some later and non-contiguous time runs another program two hours, the utility-time for that computer is said to be 3 program-execution-hours. The definition of utility-time is always measured in the application of a utility and resource type for some cumulative period.

A utility limit is some constraint on the use of a utility. An example of a utility limit is a constraint on the total utility-time a utility may be used by some entity. Another example could be on the total consumption of some utilities. For example, a network utility limit might constrain an entity from transferring data across a communications network. In general, a utility limit is a quantified constraint on some metric defined for the utility, a metric being a measurement of capacity associated with that utility.

An entity that directs the application or usage of a utility is said to control that utility. Control in this case does not mean ownership. Instead, control is meant to infer the ability to direct how a utility is applied or in fact who can employ a utility. One entity can release control of a utility to another for all time or some specified time window. Barring unforeseen circumstances (for example system outages, network interruptions, etc.), when released, the entity releasing control loses control for the time specified (or potentially permanently). An entity can also have direct control over a utility. In this case, direct control means that the entity has physical control and/or responsibility for a utility. For example, if a provider has built a data center containing many quantum computers, utilities, disk storage systems, and network infrastructure to interconnect them, that provider has direct control over those utilities. Control is an intangible property while direct control is physical.

In the context of this technology disclosed, at minimum, a package must specify the following QU-ETRs:
A collection of one or more utilities, and
A time window over which the package utilities may be controlled.

Optionally, a package might also specify such QU-ETRs as:
A transfer expiration time, a time after which control of the package can no longer be transferred from one entity to another, and
An optional set of one or more utility limits associated with the utility of the package.

The above list of items is not intended to constrain the definition or contents of a package. Entities defining packages can add additional definitions to a package as required, in essence allowing a package to be customized as required. However, packages must be defined such that an entity is in control of all the utilities specified in the package for the time window specified, either because the entity directly manages and/or owns a utility or because the entity acquired control of the utility from some other entity or entities that had control. For example, in defining a new package, an entity could disassemble the contents of another set of packages and assign subsets of their utility to the new package so long as it has control of those utility for the time window specified in the new package. In other words, the definitions of a package are flexible and could in fact be defined in terms of the contents of other packages.

A package is always controlled by an entity and such control is termed package right of use. Package right of use implies the right to control and if desired use any or all of the utilities defined in the package during the time window specified up to any of the limits specified by the package. Note that controlling a package and using the packages utilities during the specified time window are not the same thing. An entity could control a package but never use any of its utilities for example. At the end of the time window for a package, package right of use expires and the package becomes undefined. When a package is defined, the entity defining the package has initial package right of use. Any utilities contained in the package can no longer be assigned or controlled by any other entity for its specified time window. This restriction guarantees that a utility will not be over-allocated or used by more than one entity during that time window.

Package right of use can be transferred from one entity to another. Such transfer is by agreement of both parties and may be consummated for any number of reasons, but typically is done when a controlling entity sells its package right of use in return for monetary compensation, said transfer being terms a package sale. A package sale is a contract between a seller, the entity having package right of use, and a buyer, an entity that wishes to gain package right of use from the seller. The contract in this case stipulates that seller conveys package right of use to the buyer in exchange for monetary compensation from buyer to seller. After conveyance, a seller releases all further control of the package utilities for the time window specified in the package.

A canonical package is a package of standard form. For example, a package might seven define access to the following resources:
Access to quantum computing comprising a superconductive circuit computer, quantum processors/quantum chip, classical computers, quantum firmware/software, quantum algorithms, qubits of any form, microwave electronics, and quantum operating system, and
Access to a network communications network.

In addition, a single utility limit might also apply:
A limit for transfer between the systems.

If many quantum service providers (or potentially consumers) define QU-ETRs packages of exactly this description, this package is a canonical template for other supplying entities to follow. If many consumers desire packages of this form, a canonical package is advantageous to both package suppliers and consumers: suppliers will find a large, generic market for their packages and consumers will find a ready supply of these packages. The canonical package concept is akin to that found in object-oriented programming languages such as C++: a class is a template for object instances of that class.

The definition of canonical packages enables the concept of a type of package termed the Quantum Utility Exchange traded resources (QU-ETR), packages defined in bulk and defined by many entities all following a single, canonical package template. Such packages are to a degree interchangeable. As mentioned before, availability of a large number of QU-ETRs (equivalently, packages of canonical form) provides a great deal of choice for consumers wishing to employ such packages.

QU-ETRs are in a sense packaged networked components in quantum technology and thus the sale of such packaged networked components from one entity to another is performed in an exchange marketplace specific to QU-ETRs. Note that the term packaged networked components in a marketplace denotes an overall transaction in one networked component and does not refer to a physical market. QU-ETRs are subject to price fluctuations mainly related to supply and demand.

In general, a networked exchange marketplace furnishes an electronic marketplace for the purpose of QU-ETRs transaction based on different contract types. The QUE is governed by some entity managing it and quite possibly by governmental organizations above them. We can define a specific form of networked exchange marketplace in this technology disclosed with the term a Quantum Utility Exchange (QUE) used to exchange quantum utilities packages between entities: a QUE is an exchange managed by some entity for the purpose of buying and selling quantum utilities packages and/or QU-ETRs. For the purposes of this technology disclosed, there are no restrictions on what entity can establish and manage a QUE. For example, a QUE can be established and maintained by an entity that is also a provider of all packages in the exchange. Or as another example, a separate entity might establish a QUE and encourage many other entities to participate in the exchange. The only requirement is that it must be for transactions of quantum utilities packages and/or QU-ETRs, the core quantum package types.

An example of an electronic Quantum Utilities Exchange (QUE) implementation is shown in FIG. 1. In the FIGURE, there is a single QUE system 100. We envision that this system is a collection of hardware (computers, disks, network communication gear, etc.) running software implementing QUE. This system might have as little as a single computer running the entire exchange or may be in fact a large network of computers, all interconnected with a local intranet. Alternatively, there may be in fact multiple QUEs located in geographically diverse locations all interconnected through the Internet or other forms of communication. Such QUEs could share in the workload of running QU-ETR/package exchanges. Alternatively, a QUE could be implemented as part of one or more of the clouds shown in the FIGURE, Provider Cloud 110, 116, 182, and 188. In such a scenario, one or more providers host the QUE as part of their infrastructure in either a non-distributed or distributed manner. The depiction in FIG. 1 or in this description is not intended to limit the scope or structure of a QUE implementation and only serves as an example of how a QUE could be constructed and in fact employed. One skilled in the art could envision many different means of implementing a QUE or QUEs.

Continuing, in FIG. 1, there are one or more quantum utilities package provider entities 113 and 119. The FIGURE only shows two such providers, but there might in fact be as few as a single provider or an arbitrary number of providers. Each quantum provider has associated with it a Provider Cloud (110 and 116 in the FIGURE). Each quantum provider contains one or more quantum utilities resources (QURSRC) that the provider is willing to include as part of a package description. The type and structure of each quantum utility is up to the individual providers discretion and in fact can change from time to time as that provider so chooses. Throughout the following description, we will frequently refer to a provider as contacting a process or otherwise performing some action. In general, when stated as such, this means that the provider or an individual in the providers organization executing on its behalf performs some operation via a connection to an electronic infrastructure, that being either its own cloud (110 or 116 or example) or via some other computer terminal or other input/output device connected to the infrastructure shown in FIG. 1.

Likewise, there are also one or more consumer entities 180 and 186. As with providers, the FIGURE depicts two such consumers, but in fact be as few as a single consumer or an arbitrary number of consumers. Each quantum consumer has associated with it a Consumer Cloud (182 and 188 in the FIGURE). Each quantum consumer also has one more utility resource, the type and structure of each quantum utility being determined by each consumer and may vary from time to time. The purpose of each quantum utility is also up to the consumer. Typically though, the quantum utilities will be those quantum utilities that quantum providers offering. As with providers, throughout the following description, we will frequently refer to a consumer as contacting a process or otherwise performing some action. In general, when stated as such, this means that the consumer or an individual in the consumers organization executing on its behalf performs some operation via a connection to an electronic infrastructure, that being either its own cloud (182 or 188 or example) or via some other computer terminal or other input/output device connected to the infrastructure shown in FIG. 1.

As mentioned before, the FIGURE depicts a single QUE 100. In the embodiment described herein, QUE 100 is a combination of software systems running on a dedicated computer network, the exact structure of which and its construction is not relevant to this technology disclosed and is not described. Instead, conceptually, QUE 100 is a set of two databases and four major functional actions. The remainder of this description will focus on the concept and not on the exact construction of the software and hardware necessary to implement this concept, as for one skilled in the art, such construction should be straight forward.

At minimum, the QU-ETR Pending DB 148 (DB is short for database) maintains a record of all quantum utilities packages available for sale or unfulfilled bids to purchase packages thereof. Hence-forth, the QU-ETR Pending DB will simply be referred to as the pending DB. Each record in the pending DB must at minimum record which entity caused the record to come into existence, what type of record it is (offer to buy, offer to sell, etc.), what package is being offered/sought, constraints on the package price and contract types. More complex QUEs might in fact record much more information. Such additional exchange services would demand a more complex pending DB record format.

To help clarify the types of sale scenarios a QUE might need support; a few examples are provided. First, suppose a quantum provider 113 wishes to offer a quantum package for sale at a given price. That quantum provider operates software running on their cloud 110 or perhaps some other cloud, said software designed to allow a provider to define a quantum package: resources, time window, resource limits, etc. The quantum provider then contacts a Package List/Delist process 142 running on the QUE implementation via some means Comm Path 132 (Internet, Intranet, etc.) and communicates the package description to the QUE along with a list of terms of sale. For example, the provider might specify a limit price: sell the package for no less than $10. Alternatively, the sale could be at fixed price sell this package for exactly $10. Alternatively assuming the QUE supports this, the sale terms could be quite complex. For example, sell this quantum package for no less than $20 unless the package is unsold after 12 am on the date (Dec. 10, 2024) at which time sell the package at market price. Any number of market sale terms could be specified. Continuing, once the Package List/Delist process receives a directive to sell a quantum package, it records this in a record in the pending DB 148 via a communication path 162 unless a matching purchase offer is found before this. Furthermore, although not shown in FIG. 1, when the Package List/Delist process creates a new package sell offering in the pending DB 148, it might also cause the Package Record process 150 via communication path 166 to record the existence of the package in QU-ETR Recorded DB 144; such recordation is optional. Recordation of packages in this DB will be discussed further below.

Another sales scenario might allow a provider to place for sale a large number of QU-ETRs. Recall that a QU-ETR is simply a form of quantum package, the packages being completely interchangeable. For example, assume provider 119 has a collection of 1000 identical quantum utilities available 116 and that these quantum utilities will be idle/not used on Dec. 11, 2024, unless the quantum provider can sell packages before then. Provider 119 constructs a QU-ETR for these servers using a mechanism similar to the process provider 113 used above to con-struct a package for a single server. In this case, provider 119 specifies the date and duration (24-hour period in this case), but leaves the quantum utilities resource specification as generic or some other means as required. Provider 119 does not actually care at the time the QU-ETR is created what server will eventually be used by some consumer as all of its utilities are interchangeable; such assignment will be performed on demand at the time a consumer actually goes to use a server. In fact, quantum provider 119 might dynamically reassign utilities at its choosing while a consumer is using its utility resources. A quantum package sold to a consumer only requires the quantum provider to guarantee access to the utility as specified in the package. In a sense, generic is a wild card, allowing a quantum provider to substitute any specific quantum utility resource of its own choosing at any time. To one skilled in the art, it tilitd be apparent that many alternate forms of constraints on which utilities are being allocated are possible and that the technology disclosed described herein is not intended to describe all possible constraint specifications. However, we envision that queries on the database could be at least as powerful as those allowed by such databases such as SQL.

As its name implies, a provider is also allowed to delist an offering via the Package List/Delist process 142. For example, assume provider 113 wishes to no longer sell a quantum package it had constructed and listed for sale. Provider 113 contacts process 142 via some means along communications path 132 providing a sufficient description of the package it wishes to delist. Process 142 searches the pending DB 148 via communication path 162 for this quantum package. If found, process 142 destroys the matching record in the pending DB 148 and reports success to provider 113 along communications path 132. Otherwise process 142 reports failure. Such a facility obviously also allows a provider to search for arbitrary packages or QU-ETRs, the exact means and capabilities of such queries not specified herein. Similarly, a provider could also search for an delist QU-ETRs using a similar search process.

Quantum Consumers can also search for and bid to purchase quantum packages and QU-ETRs. For example, Package Consumer 180 might contact the Package Search/Bid process 152 via communications path 176. Consumer 180 specifies to process 152 via electronic or other means what type of package is desired and under what purchase terms and conditions. For example, the consumer might say that it requires at least some performance level with some amount of quantum system configuration and capabilities and capacity. The quantum consumer could specify a simple or perhaps complex set of requirements on the quantum package it desires including the range of time windows desired. In addition to package requirements, the consumer must also specify the sales terms. For example, a limit price might be set to pay no more than $8 for this package. Alternatively, a fixed price could be set to-pay exactly $6 for this package. Alternatively assuming the QUE supports this, the purchase terms could be quite complex. For example, purchase this package for no more than $5 unless no package is purchased after 12 am on Dec. 18, 2014, at which time purchase the package at market price. Any number of market purchase terms could be specified. Continuing, once the Package Search/Bid process 152 receives a directive to purchase a package, it records this in a record in the pending DB 148 via a communication path 170 unless a matching sell offer is found before this.

Another quantum purchase scenario might allow a consumer to request a purchase of a large number of packages via a QU-ETR template. For example, assume a consumer 186 wishes to purchase a number of packages of a generic type on or before Dec. 19, 2024. Consumer 186 constructs a QU-ETR definition for these packages using a mechanism similar to the process consumer 180 used above to construct a request for a single package. In this case, consumer 186 specifies a date range, any date on or before Dec. 18, 2024, and a duration as desired, but leaves the utility resource specification as generic or some other means as required. As with the case of a provider creating a QU-ETR record, consumer 186 does not actually care at the time the QU-ETR is created what utility resources will eventually be used as all of servers matching what the consumer wants are interchangeable; such assignment will be performed on demand at the time a consumer actually goes to use a utility. As with the provider case, the consumer here is using generic as a wild card, allowing a match to any provider offering that matches its needs. To one skilled in the art, it should be apparent that many alternate forms of constraints of specifying needs and wants on a consumer's part are possible and that the technology disclosed described herein is not intended to describe all possible constraint specifications. However as before, we envision that queries on the database could be at least as powerful as those allowed by such databases such as SQL. Consumer 186 completes a QU-ETR bid by contacting the Package Search/Bid process 152 via communications path 178. Package Search/Bid process 152 queries the pending DB 152 via communications path 170 for a matching offering and if none is found, records the bid offer in the database. Once either a matching sale bid is found or bid placed, the Package Search/Bid process 152 informs Consumer 186 via path 178 of the status of the bid.

As mentioned for both sale and purchase bid scenarios above, before an entry is created in the pending DB 148 to record a pending sale or purchase order, the processes Package List/Delist 142 and Package Search/Bid 152 must search the DB to see if a pending offer already matches a new request about to be posted. If so, the process doing the search (either 142 or 152) instead of adding a new pending record proceeds to consummate the transaction using an already existing record in the pending DB 148. If multiple offerings match a pending request, the process is free to choose one such pending as it so desires, the means of selection not described here. However for example, it could choose best price on either a buyer or seller behalf, or perhaps choose a record based upon when it was entered in the DB. It should be clear to one skilled in the art that many such decision-making selection algorithms are possible.

Once a pending offer is selected against a pending request, the process making that selection (142 or 152) delists the pending offer and forwards the sale information to the Package Record process 150 via communication pathway 166 or 174 as appropriate. The Package Record process 150 then notes the sale as completed, recording the sale in the QU-ETR Recorded DB 144 via communications path 168. The QU-ETR Recorded DB 144 will henceforth be referred to as recorded DB for short. It is important that any one package be shown as having only one controlling entity at a time, the entity with current package right of use. The means by which this is implemented in the recorded DB 144 is not specified by this technology disclosed; to those skilled in the art, many such techniques to accomplish uniqueness in a DB should be readily apparent. What is important is that all package right of use transactions must be recorded in the recorded DB such that the entity currently having right of use for a package is known and a description of the package resources and which core providers are providing the resources are also specified (directly or indirectly). This enables the entity with current right of use to actually control and/or employ the quantum utilities resources specified in the package. Continuing, once recorded, the Package Record process 150 may inform all interested parties, the providers directly controlling the resources specified in the package, the entity that created the package sell offering, and the entity purchasing the package that the sale has completed and that package right of use has transferred to the new owner, all of this via communications path 133. The exchange of information regarding packages is through private tunnels and data is encrypted before the tunnel transport and received encrypted on the other end of the tunnel, we are calling this method “trucking”.

Consumers can also function as providers by turning around and creating packages a QU-ETRs and posting them for sale using resources they have acquired package right of use for. This in effect allows consumers to turn into investors or speculators. A consumer might have no intention of actually using any utilities resources in any of the pack-ages or QU-ETRs for they acquire package right of use. Instead, they might simply turn around and offer these packages and QU-ETRs for resale in the QUE. Or they might break apart one or more packages or QU-ETRs and define new packages or QU-ETRs for sale. In FIG. 1, this is accomplished by allowing consumers (180 and 186 as shown in the FIGURE) to communicate with the Package List/Delist process 142 via communications path 172. Such consumers would create packages or QU-ETRs or sell existing packages and QU-ETRs through this process in a manner similar to that employed by providers as described above.

Providers might also be allowed to bid and purchase packages and/or from QU-ETRs in the same manner as consumers. This is shown in FIG. 1 with providers 113 and 119 being able to communicate with the Package Search/Bid process via communications path 173. Being able to purchase packages allows a provider to bundle utilities resources from the packages it has purchased into new packages or in fact use those packages themselves acting as consumers, all this once it has right of use for those packets.

Bids to purchase or sell quantum utilities packages or QU-ETRs might not succeed. For example, a package or QU-ETR transfer expiration time might be exceeded if specified or the time window for a package or QU-ETR might lapse. Or a consumer wishing to purchase a package or QU-ETR might have specified a time limit on such purchase that might have lapsed. In such an event, the Pack-age List/Delist process 142 might optionally inform the provider or consumer defining the package or QU-ETR order that such expiration has occurred via a communication pathways as required (132, 136, 172, 173, 176, or 178).

At some point, an entity with package right of use might want to employ the utilities contained in the associated quantum packet. To do so, it must know where to locate those utilities which means tracing back the resources to the providers that have direct control. Such knowledge must be recorded in the recorded DB 144 in some fashion. The means by which a resource can be used and how a consumer should contact the provider with direct control is not specified herein, although it should be clear to one skilled in the art how one might implement this contact. In FIG. 1, a consumer 180 or 186 contacts a provider 113 or 119 via communications path 175. This path forms the basis for all communications with the resources specified in the package for which it has package right of use.

At the termination of path 175 are a pair of Access Control gates 124 and 128. Only two such gates are shown in FIG. 1, but a QUE-based infrastructure may in fact have only one such gate or many such gates. The implementation of the gate may be a combination of hardware and software or just hardware or software alone. The function of each gate is to prevent improper use of a resource by an entity without package right of use for that resource. Each gate is controlled by its provider as shown in FIG. 1 as Access Enable controls 122 and 126.

To determine if access to a resource is to be permitted, a provider (113 or 119 as shown) must first determine if an entity that claims package right of use to a resource does indeed have that right. This can only be accomplished if the provider can first validate that communication along path 175 is in fact from the entity that has package right of use and not some impostor entity such as botnets. The communication for the validation of the right of ownership will take place using private communication tunnel where communication data gets encrypted on both ends-on the provider and consumer sides.

Any number of means to validate identity electronically are possible such as SecureID from RSA (see http://www.rsa.com/node.aspx?id=1156). Alternatively, a system as described in SECURE AND POSITIVE AUTHENTICATION ACROSS A NETWORK may be employed (see U.S. patent application No. 20100095117). The exact means by which identification is secured is not specified in this technology disclosed and one skilled in the art can select from any number of such mechanisms.

Next, once identity is established, the provider must determine if in fact the requested utilities accesses are granted via a package. To do so, providers contact a Package Validate process 140 in the QUE via communication paths 130 and 134 respectively. Although only two such paths are shown in FIG. 1, there may be in fact only one such connection or in fact many such connections. The Package Validate process 140 responds to queries from the providers asking for validation of package right of use and package definition by searching the recorded DB 144 using path 160 for the most recent recordation of package right of use for a specified package. The Package Validate process 140 then responds either affirmatively or not whether the entity attempting resource use does indeed have that right or whether access should be denied. The Package Validate process 140 uses path 130 or 134 to respond back to the appropriate provider with direct resource control. Once access is granted, an entity with package right of use to re-sources specified in some packet communicates along path 175 as required to gain access to an employ those resources. It is presumed that the provider with direct control of those resources monitors such communication and will cut off this communication if resource limit is reached and/or the time window for the package expires. All these communications will be through private tunnel and the data will be encrypted on both end of the tunnel.

In addition to the ability to sell, purchase, and employ resources via packages and QU-ETRs, the information stored in the pending and recorded databases can be mined to provide any entity in communication with and with access to such mining capabilities invaluable information. Such information could be used for example to predict future use patterns of resources, packages, QU-ETRs, future price projections, etc. The meaning of term data mining and all it implies should be apparent to one skilled in the art.

Note that forgoing description has described the QUE 100 implementation as set of four processes and two databases. Nothing in this technology disclosed is written to imply that this is the only means of implementing a QUE. The above processes could be in fact merged or further split into other processes and implemented in a variety of means. The two databases could be merged into a single database or in fact be split into many databases or various function. It should be apparent to one skilled in the art that there are many possible means of implementing a QUE.

From the foregoing description, it will thus be evident that the present technology disclosed provides what is covered. As various changes can be made in the above embodiments and operating methods without departing from the spirit or scope of the following claims, it is intended that all matter contained in the above description or shown in the accompanying drawings should be interpreted as illustrative and not in a limiting sense.

Variations or modifications to the design and construction of this technology disclosed, within the scope of the appended claims, may occur to those skilled in the art upon reviewing the disclosure herein (especially to those using computer aided design systems). Such variations or modifications, if within the spirit of this technology disclosed, are intended to be encompassed within the scope of any claims to patent protection is-suing upon this technology disclosed.

### CLAUSES

We disclose the following clauses:
1. A method of managing quantum computing resources, the method comprising:
one or a plurality of provider entities defining packages and Quantum Utility Exchange Traded Resources (QU-ETRs) that grant package right of use for one or a plurality of quantum computing utilities or classes of quantum computing utilities, each provider entity having direct control over the computing resources or classes of computing resources defined in each said package or said QU-ETR;
for each defined package or QU-ETR, recording a specific entity that has package right of use for said package or said QU-ETR; and
a Quantum Utility Exchange to trade packages or QU-ETRs between entities, said quantum technology conveying package right of use of one or a plurality of packages or QU-ETRs between a seller and entity in exchange for monetary compensation, the permission to access the QUE, QU-ETRs, and communications are through an internal blockchain module.
2. The method of clause 1, wherein a package or QU-ETR definition may include information specifying resource limits on one or a plurality of the utilities or classes of quantum computing utilities in said package or said QU-ETR.
3. The method of clause 1, wherein a package or QU-ETR definition may include a time window specifying when the utilities in said package or said QU-ETR may be used by the entity having package right of use for said package or said QU-ETR.
4. The method of clause 1, wherein a package or QU-ETR definition may include both a time window specifying when the resources in said package or said QU-ETR may be used by the entity having package right of use for said package or said QU-ETR and information specifying utilities limits on one or a plurality of the utilities or classes of quantum computing utilities in said package or said QU-ETR.
5. The method of clause 1, wherein a plurality of quantum technology exchanges is employed to buy and sale quantum utilities packages or QU-ETRs.
6. The method of clause 1, wherein:
as they are defined by one or a plurality of provider entities, packages or QU-ETRs are listed in a Recorded Database; After the time window for any listed package or QU-ETR expires or when any utility limit for said listed package or QU-ETR is reached through use of a utility defined in said listed package or QU-ETR, said listed package or QU-ETR is delisted from said Recorded Database.
7. The method of clause 6, wherein each listed package or QU-ETR record in a Recorded Database specifies which entity has package right of use for said package or QU-ETR and specifies a complete description of the utility or classes of utilities in said listed package or QU-ETR, any time window for said package or QU-ETR, and any resource limits on one or a plurality of the utility or utilities classes in said package or QU-ETR.
8. The method of clause 1, wherein:
packages or QU-ETRs offered for sale are listed in a Pending Database;
packages or QU-ETRs offered for purchase are listed in said Pending Database;
packages or QU-ETRs traded between buyer and seller entities are delisted from said Pending Database; and
packages or QU-ETRs can be searched by a prompt from users where generative AI-ML engine provides the information for the search.
9. The method of clause 8, wherein each listed package or QU-ETR in a Pending Database specifies the entity caused the listing to come into existence, whether said listing is an offer to purchase or an offer to sell the package or QU-ETR in said listing, and a constraint of the price of said listing.
10. The method of clause 8, where in each package or QU-ETR listed in the Pending Database as offered for sale has a corresponding listed record in the Recorded Database.
11. The method of clause 8, wherein:
buyer entities may search the Pending Database using a Pending Search/Bid process for listed records recorded as offered for sale that meet criteria they specify; Seller entities may search the Pending Database using a Pending Search/Bid process for listed records recorded as offered for purchase that meet criteria they specify.
12. The method of clause 7, wherein as packages or QU-ETRs are sold in a quantum utilities exchange, a Package Record process updates the corresponding listed record in the Recorded Database to reflect the buyer entity now having package right of use for said packages or QU-ETRs.
13. A method of operating a Quantum Utility Exchange to trade quantum computing utilities, the method comprising:
receiving utilities packages from provider entities;
listing quantum computing utilities packages;
storing and organizing utilities packages for end-delivery to entities;
distributing resource packages in the exchange;
transactions on utilities packages by means of “buy now-pay now-use now”, “buy now-pay now-use later”, “buy now-pay later-use later”, or swap contract types;
upon ownership transfer (sell) of utilities packages, requiring entry into a specified database;
all communications between providers, consumers, and the QUE system is through private tunnels set for communications data and data transfer as well as data is encrypted on both end of the tunnel;
delisting (Removing) previously listed quantum utilities packages from the exchange;
searching quantum computing resource packages; and
bidding to take ownership of quantum utilities packages on specific date.
14. The method of clause 13, further comprising:
providing an exchange interface for quantum service providers operationally coupled with the computer system and accessible via a computer network, through which quantum service providers can submit and remove utilities packages, search, download utilities packages; and
providing an exchange interface for quantum consumers operationally coupled with the computer system and accessible via a computer network, through which consumers can search, bit, request quantum utilities packages.
15. The method of clause 14, wherein the computer system comprises a network of computers.
16. The method of clause 14, wherein the exchange interface comprises a set of web pages including a login page and a utilities package information pages.
17. The method of clause 13, wherein quantum computing resource packages termed a Quantum Utility Exchange Traded Resources (QU-ETRs), comprises a collection of one or more resources as quantum networked resources; and a time window over which the package resources may be controlled; a transfer expiration time, and resource limit.
18. The method of clause 17, wherein the transfer expiration time comprises a time after which control of the utilities package can no longer be transferred from one entity to another.
19. The method of clause 17, wherein utilities limits comprise an optional set of one or more utilities limits associated with the utilities of the package.
20. The method of clause 13, wherein receiving comprises receiving the utilities packages via quantum service providers interface and receiving the utilities packages via a non-computer-network-based interface.
21. The method of clause 13, wherein listing comprises a resource package description, type and structure of each utility.
22. The method of clause 22, comprising a assigning a code to each utilities package.
23. The method of clause 13, wherein storing and organizing comprises storing utilities packages information and categorizing the listing in the exchange pending database.
24. The method of clause 13, wherein distribution comprises validation and verification of utilities packages and recording the information in the exchange recording database.
25. The method of clause 13, wherein transaction comprises transaction of utilities packages in the exchange by means of “buy now-pay now-use now”, “buy now-pay now-use later”, “buy now-pay later-use later”, or swap contract types.
26. The method of clause 13, wherein transfer comprises recording the transfer of ownership of utilities packages in recording database.
27. The method of clause 13, wherein delisting comprises removing utilities packages from the exchange and marking them unavailable for transaction.
28. The method of clause 13, wherein searching comprises searching of utilities packages by entities in the recorded database.
29. The method of clause 13, comprising alerting an entity when utilities package is available wherein the alerting step is performed by the computer system.
30. The method of clause 13, wherein bidding comprises bidding on utilities packages to take ownership on specific date.
31. A system, comprising:
databases for storing entity membership information, utilities package pending, utilities package recording;
software system for verification and validation of resource packages, and distribution to databases; and
interface for accessing, viewing resource packages available for any contract type transactions.

1. A method of managing quantum computing resources, the method comprising:
one or a plurality of provider entities defining packages and Quantum Utility Exchange Traded Resources (QU-ETRs) that grant package right of use for one or a plurality of quantum computing utilities or classes of quantum computing utilities, each provider entity having direct control over the computing resources or classes of computing resources defined in each said package or said QU-ETR;
for each defined package or QU-ETR, recording a specific entity that has package right of use for said package or said QU-ETR; and
a Quantum Utility Exchange to trade packages or QU-ETRs between entities, said quantum technology conveying package right of use of one or a plurality of packages or QU-ETRs between a seller and entity in exchange for monetary compensation, the permission to access the QUE, QU-ETRs, and communications are through an internal blockchain module.

2. The method of claim 1, wherein a package or QU-ETR definition may include information specifying resource limits on one or a plurality of the utilities or classes of quantum computing utilities in said package or said QU-ETR.

3. The method of claim 1, wherein a package or QU-ETR definition may include a time window specifying when the utilities in said package or said QU-ETR may be used by the entity having package right of use for said package or said QU-ETR.

4. The method of claim 1, wherein a package or QU-ETR definition may include both a time window specifying when the resources in said package or said QU-ETR may be used by the entity having package right of use for said package or said QU-ETR and information specifying utilities limits on one or a plurality of the utilities or classes of quantum computing utilities in said package or said QU-ETR.

5. The method of claim 1, wherein a plurality of quantum technology exchanges is employed to buy and sale quantum utilities packages or QU-ETRs.

6. The method of claim 1, wherein:
as they are defined by one or a plurality of provider entities, packages or QU-ETRs are listed in a Recorded Database; After the time window for any listed package or QU-ETR expires or when any utility limit for said listed package or QU-ETR is reached through use of a utility defined in said listed package or QU-ETR, said listed package or QU-ETR is delisted from said Recorded Database.

7. The method of claim 6, wherein each listed package or QU-ETR record in a Recorded Database specifies which entity has package right of use for said package or QU-ETR and specifies a complete description of the utility or classes of utilities in said listed package or QU-ETR, any time window for said package or QU-ETR, and any resource limits on one or a plurality of the utility or utilities classes in said package or QU-ETR.

8. The method of claim 1, wherein:
packages or QU-ETRs offered for sale are listed in a Pending Database;
packages or QU-ETRs offered for purchase are listed in said Pending Database;
packages or QU-ETRs traded between buyer and seller entities are delisted from said Pending Database; and
packages or QU-ETRs can be searched by a prompt from users where generative AI-ML engine provides the information for the search.

9. The method of claim 8, wherein each listed package or QU-ETR in a Pending Database specifies the entity caused the listing to come into existence, whether said listing is an offer to purchase or an offer to sell the package or QU-ETR in said listing, and a constraint of the price of said listing.

10. The method of claim 8, where in each package or QU-ETR listed in the Pending Database as offered for sale has a corresponding listed record in the Recorded Database.

11. The method of claim 8, wherein:
buyer entities may search the Pending Database using a Pending Search/Bid process for listed records recorded as offered for sale that meet criteria they specify; Seller entities may search the Pending Database using a Pending Search/Bid process for listed records recorded as offered for purchase that meet criteria they specify.

12. The method of claim 7, wherein as packages or QU-ETRs are sold in a quantum utilities exchange, a Package Record process updates the corresponding listed record in the Recorded Database to reflect the buyer entity now having package right of use for said packages or QU-ETRs.

13. A method of operating a Quantum Utility Exchange to trade quantum computing utilities, the method comprising:
receiving utilities packages from provider entities;
listing quantum computing utilities packages;
storing and organizing utilities packages for end-delivery to entities;
distributing resource packages in the exchange;
transactions on utilities packages by means of “buy now-pay now-use now”, “buy now-pay now-use later”, “buy now-pay later-use later”, or swap contract types;
upon ownership transfer (sell) of utilities packages, requiring entry into a specified database;
all communications between providers, consumers, and the QUE system is through private tunnels set for communications data and data transfer as well as data is encrypted on both end of the tunnel;
delisting (Removing) previously listed quantum utilities packages from the exchange;
searching quantum computing resource packages; and
bidding to take ownership of quantum utilities packages on specific date.

14. The method of claim 13, further comprising:
providing an exchange interface for quantum service providers operationally coupled with the computer system and accessible via a computer network, through which quantum service providers can submit and remove utilities packages, search, download utilities packages; and
providing an exchange interface for quantum consumers operationally coupled with the computer system and accessible via a computer network, through which consumers can search, bit, request quantum utilities packages.

15. The method of claim 14, wherein the computer system comprises a network of computers.

16. The method of claim 14, wherein the exchange interface comprises a set of web pages including a login page and a utilities package information pages.

17. The method of claim 13, wherein quantum computing resource packages termed a Quantum Utility Exchange Traded Resources (QU-ETRs), comprises a collection of one or more resources as quantum networked resources; and a time window over which the package resources may be controlled; a transfer expiration time, and resource limit.

18. The method of claim 17, wherein the transfer expiration time comprises a time after which control of the utilities package can no longer be transferred from one entity to another.

19. The method of claim 17, wherein utilities limits comprise an optional set of one or more utilities limits associated with the utilities of the package.

20. The method of claim 13, wherein receiving comprises receiving the utilities packages via quantum service providers interface and receiving the utilities packages via a non-computer-network-based interface.
